(19) United States
(12) Patent Application Publication
(10) Pub. No.: US 2018/0194972 A1
(43) Pub. Date: Jul. 12, 2018

(54) ADHESIVE LAMINATE AND METHOD FOR MAKING RETROREFLECTIVE TAPE WITH THE ADHESIVE LAMINATE

(71) Applicant: Yuh-Jye Uang, Taichung City (TW)

(72) Inventor: Yuh-Jye Uang, Taichung City (TW)

(21) Appl. No.: 15/404,188

(22) Filed: Jan. 11, 2017

(51) Int. Cl. C09J 7/02; C09J 5/00; C09J 175/04; C09J 121/00

(52) U.S. Cl. CPC C09J 7/0292; C09J 5/00; C09J 175/04; C09J 2421/00; C09J 2400/163; C09J 2475/00; C09J 121/00

(57) ABSTRACT

Provided is an adhesive laminate and a method for making retroreflective tapes with the adhesive laminate. The adhesive laminate is coated and laminated on the conventional retroreflective substrate. The adhesive laminate comprises: a retroreflective substrate adhesive layer and a temporary carrier adhesive layer. The adhesive laminate may further comprise a cross-linking layer between the retroreflective substrate adhesive layer and the temporary carrier adhesive layer. The adhesive laminate has excellent adhesion to rubber articles. The conventional retroreflective substrate may be attached on the rubber articles firmly by the adhesive laminate. The adhesive laminate may not deform or be damaged during attachment process. The adhesive laminate also may not peel off from the rubber articles after use over time. Rubber articles with the adhesive laminate have lasting light-reflecting and alerting effects with enhanced safety.

### BACKGROUND OF THE INVENTION

### 1. Field of the Invention

The present invention relates to an adhesive laminate for a retroreflective substrate and more particularly to an adhesive laminate for adhering the retroreflective substrate to a rubber material. The present invention further relates to a method for making a retroreflective tape with the adhesive laminate.

### 2. Description of the Related Art

A conventional first type retroreflective substrate 90A as shown in FIG. 5 sequentially comprises: a polyester (PET) film 91, a release layer 92, a coating surface 93, a primer 94, an adhesive coating 95, and a glass sphere-lens layer 96 partially implanted in the adhesive coating 95 from the top surface toward the bottom surface. A conventional second type retroreflective substrate 90B as shown in FIG. 6 sequentially comprises: a PET film 91, a release layer 92, a coating surface 93, a primer 94, an adhesive coating 95, a glass sphere-lens layer 96 partially implanted in the adhesive coating 95, and a deposited aluminum layer 97 covered on the adhesive coating 95 and the glass sphere-lens layer 96 from the top surface toward the bottom surface.

With reference to FIGS. 5 and 6, both the first type retroreflective substrate 90A and the second type retroreflective substrate 90B utilize a liner 100 to attach on the glass sphere-lens layer 96 or the deposited aluminum layer 97 respectively. The first type retroreflective substrate 90A and the second type retroreflective substrate 90B both may be attached on rubber articles through the liner 100 respectively.

Over long time of use, however, users find that the liner 100 does not have good adhesion to the rubber articles. The retroreflective substrates attached on the rubber articles such as tires and shoes gradually detach and fall off. The liner 100 loses its adhesion and may not be used again. It affects the safety for drivers or pedestrians at night as the light-reflecting and alerting effects are lost.

In addition, U.S. Pat. Nos. 3,382,908 and 3,449,201 respectively disclose a sheet material comprising a vulcanizable elastomer of a retroreflective member support layer. The sheet material is a single-layer construction which may be attached on the rubber articles firmly. However the sheet material is too thin to overcome the bending and the stretching during attachment process of retroreflective member. The sheet material is easy to crack or deform during the attachment process. After cracking or deforming, the sheet material is no longer capable for use.

### SUMMARY OF THE INVENTION

An objective of the present invention is to provide an adhesive laminate that may be attached with the rubber articles firmly and may not detach from the rubber articles over long term of use. Moreover, the adhesive laminate also may not crack or deform by excessive tension. The adhesive laminate is made of specific materials and formed in specific thickness. The adhesive laminate helps a retroreflective substrate to be attached on tires or shoes firmly and enhances the safety for drivers or pedestrians at night.

To achieve the foregoing objective, an adhesive laminate of the present invention comprises:

a retroreflective substrate adhesive layer having an adhesive surface and comprising resin and a solvent; and

a temporary carrier adhesive layer disposed on a surface of the retroreflective substrate adhesive layer opposite the adhesive surface and comprising a rubber adhesive and a rubber solvent.

The advantage of the present invention is that utilizing the retroreflective substrate adhesive layer that cross-links with the retroreflective substrate and the temporary carrier adhesive layer that cross-links with the retroreflective substrate adhesive layer to attach the retroreflective substrate on the rubber articles firmly. The adhesive laminate enhances the traffic safety at night when the retroreflective substrate is attached on the tires through the adhesive laminate. Furthermore, the adhesive laminate also enhances the pedestrian safety at night when the retroreflective substrate is attached on the shoes by the adhesive laminate.

Preferably, at least one cross-linking layer is formed between the retroreflective substrate adhesive layer and the temporary carrier adhesive layer. The at least one cross-linking layer comprises polyurethane (PU) and rubber adhesive. The advantage of the present invention is that utilizing the at least one cross-linking layer to enhance the elasticities and the durabilities for tension of the adhesive laminate. The at least one cross-linking layer ensures the retroreflective substrate would not deform and crack during attachment process. The retroreflective substrate may maintain its adhesion and shape resistance.

More preferably, the resin is PU, acrylic, epoxy, or a combination thereof. The retroreflective substrate adhesive layer further comprises: a catalyst and an additive. The catalyst is an organometallic compound and amino compound. The additive is a silane coupling agent. The advantage of the present invention is utilizing the resin compound to attach the retroreflective substrate adhesive layer with the retroreflective substrate by cross-linking reaction. In addition, the catalyst and the additive enhance the elasticities, adhesion, and cross-linking capabilities for the retroreflective substrate adhesive layer.

Most preferably, the PU with the retroreflective substrate adhesive layer and the PU with the cross-linking layer are PU adhesives respectively. The PU adhesives comprise at least one diisocyanate, at least one polyisocyanate, at least one polyol, at least one product from unsaturated polyol, and at least one chain extender. The at least one diisocyanate and the at least one polyisocyanate are aliphatic isocyanate, alicyclic isocyanate, aromatic isocyanate, heterocyclic isocyanate, or a combination thereof respectively. The at least one polyol is polycaprolactone (PCL) polyol, polycarbonate polyol, PU diol, polyester polyol, or a combination thereof. The at least one product from unsaturated polyol is hydroxyl-terminated polybutadiene (HTPB) material or hydroxyl-terminated butadiene acrylonitrile cooligomer liquid rubber. The at least one chain extender is diol or triol such as ethylene glycol or trimethylolpropane (TMP). The advantage of the present invention is utilizing the structural properties of the diisocyanate, polyisocyanate, polyol, unsaturated polyol to react with the retroreflective substrate by cross-linking reaction based on at least one functional group. The adhesive laminate of the present invention may be laminated on the retroreflective substrate firmly.

And most preferably, the organometallic compound is di-methyltin dilaurate salt or di-n-butyltin dilaurate salt. The amino compound is triethylenediamine or (dimethylamino)ethyl phenol. The silane coupling agent is triethoxyoctylsilane or 3-(glycidoxypropyl)methyldiethoxysilane.

More preferably, the retroreflective substrate adhesive layer further comprises ink. The color of the ink is not limited. The advantage of the present invention is utilizing different colors of the ink to induce colorful reflected light from the retroreflective substrate adhesive layer. The adhesive laminate of the present invention may produce diverse retroreflective effects.

Preferably, the rubber adhesive with the temporary carrier adhesive layer comprises: a rubber component, a tackifier, a plasticizer, a filler, a vulcanization accelerator, an activator, a softener, a rubber scorch retarder, an antiozonant, an antioxidant, a solvent, and an additive. The additive is a vulcanizing agent or a silane coupling agent. The rubber component is natural rubber, synthetic rubber, or a combination thereof; the synthetic rubber is chloroprene rubber (CR), styrene butadiene rubber (SBR), polybutadiene rubber (BR), nitrile butadiene rubber (NBR), isoprene rubber (IR), butyl rubber (IIR), ethylene propylene diene monomer rubber (EPDM), or a combination thereof. The tackifier is rosin ester, polymerized rosin, terpene, polyterpene, styrenated terpene, terpene phenolic, petroleum hydrocarbon, or a combination thereof. The plasticizer is mineral oil, polybutene (PB), isoprene rubber, or a combination thereof. The filler is kaolinite, mica, titanium dioxide, silicon dioxide, talc powder, carbon black, or a combination thereof. The vulcanization accelerator is thiazole accelerator, sulfenamide accelerator, guanidine accelerator, dithiocarbamate accelerator, thiourea accelerator, thiuram accelerator, or a combination thereof. The activator is zinc oxide. The softener is mineral oil, paraffin wax liquid, linseed oil, coconut oil, paraffin wax, carnauba wax, stearic acid, palmitic acid, or a combination thereof. The rubber scorch retarder is phthalic anhydride (PA), salicylic acid, benzoic acid, N-nitrosodiphenylamine, phthalimidesulfenamide, or a combination thereof. The antiozonant is microcrystalline wax, paraffin wax, natural asphalt extraction, or a combination thereof. The antioxidant is N-phenyl-N′-(1,3-dimethyl butyl)-p-phenylenediamine (6PPD), N,N′-diphenyl-p-phenylene diamine (DPPD), octylated diphenylamine (ODPA), 2-mercaptobenzimidazole (MB), 2,6-di-tert-butyl-4-methylphenol (BHT), or a combination thereof. The solvent is n-heptane, n-hexane, n-pentane, cyclohexane, methylcyclohexane, xylene, toluene, high flash naphtha, petroleum naphtha, or a combination thereof. The vulcanizing agent is sulfur or 4,4′-dithiodimorpholine. The silane coupling agent is triethoxyoctylsilane, 3-(glycidoxypropyl) methyldiethoxysilane, bis(triethoxy)silane derivative, sodium polysulphide, or a combination thereof.

Most preferably, the rubber adhesive of the cross-linking layer comprises: a rubber component, a tackifier, a plasticizer, a filler, a vulcanization accelerator, an activator, a softener, a rubber scorch retarder, an antiozonant, an antioxidant, a solvent, and an additive. The additive is a vulcanizing agent or a silane coupling agent. The rubber component is natural rubber, synthetic rubber, or a combination thereof. The synthetic rubber is CR, SBR, BR, NBR, IR, IIR, EPDM, or a combination thereof. The tackifier is rosin ester, polymerized rosin, terpene, polyterpene, styrenated terpene, terpene phenolic, petroleum hydrocarbon, or a combination thereof. The plasticizer is mineral oil, PB, isoprene rubber, or a combination thereof. The filler is kaolinite, mica, titanium dioxide, silicon dioxide, talc powder, or a combination thereof. The vulcanization accelerator is thiazole accelerator, sulfenamide accelerator, guanidine accelerator, dithiocarbamate accelerator, thiourea accelerator, thiuram accelerator, or a combination thereof. The activator is zinc oxide. The softener is mineral oil, paraffin wax liquid, linseed oil, coconut oil, paraffin wax, carnauba wax, stearic acid, palmitic acid, or a combination thereof. The rubber scorch retarder is PA, salicylic acid, benzoic acid, N-nitrosodiphenylamine, phthalimidesulfenamide, or a combination thereof. The antiozonant is microcrystalline wax, paraffin wax, natural asphalt extraction, or a combination thereof. The antioxidant is 6PPD, DPPD, ODPA, MB, BHT, or a combination thereof. The solvent is n-heptane, n-hexane, n-pentane, cyclohexane, methylcyclohexane, xylene, toluene, high flash naphtha, petroleum naphtha, or a combination thereof. The vulcanizing agent is sulfur or 4,4′-dithiodimorpholine. The silane coupling agent is triethoxyoctylsilane, 3-(glycidoxypropyl) methyldiethoxysilane, bis(triethoxy)silane derivative, sodium polysulphide, or a combination thereof.

The present invention further provides a method for making retroreflective tapes with the above adhesive laminate comprising:

providing a retroreflective substrate;

coating the retroreflective substrate adhesive layer on a side of the retroreflective substrate;

coating the temporary carrier adhesive layer on another side of the retroreflective substrate opposite the retroreflective substrate adhesive layer;

pasting the temporary carrier on a side of the temporary carrier adhesive layer opposite the retroreflective substrate adhesive layer.

The advantage of the present invention is forming the retroreflective substrate adhesive layer and the temporary carrier adhesive layer on the retroreflective substrate sequentially by cross-linking reactions to laminate an adhesive laminate on the retroreflective substrate. The adhesive laminate may help the retroreflective substrate bind together with rubber articles. The retroreflective tapes would not detach from the rubber articles by the adhesive laminate over long term of use. The retroreflective tapes provide safety alerting with reflected light from the rubber articles at night.

Preferably, the coating rate of the retroreflective substrate adhesive layer is 3 m to 20 m per minute. The dry temperature of the retroreflective substrate adhesive layer is 80° C. to 115° C. The natural aging time of the retroreflective substrate adhesive layer is 2 to 10 hours. The thickness of the retroreflective substrate adhesive layer ranges from 0.04 mm to 0.1 mm. The coating rate of the temporary carrier adhesive layer is 3 m to 20 m per minute. The dry temperature of the temporary carrier adhesive layer is 80° C. to 120° C. The natural aging time of the temporary carrier adhesive layer is 2 to 10 hours. The thickness of the temporary carrier adhesive layer ranges from 0.04 mm to 0.1 mm. The advantage of the present invention is utilizing the stable coating rate to dispose the retroreflective substrate adhesive layer and the temporary carrier adhesive layer on the surface of retroreflective substrate smoothly and thinly. The drying step with high temperature accelerates aging of the retroreflective substrate adhesive layer and the temporary carrier adhesive layer.

More preferably, at least one cross-linking layer is coated between the retroreflective substrate adhesive layer and the temporary carrier adhesive layer. The coating rate of the cross-linking layer is 3 m to 20 m per minute. The dry temperature of the cross-linking layer is 80° C. to 125° C. The natural aging time of the cross-linking layer is 2 to 10 hours. The thickness of the cross-linking layer ranges from 0.04 mm to 0.15 mm. The advantage of the present invention is utilizing the at least one cross-linking layer between the retroreflective substrate adhesive layer and the temporary carrier adhesive layer to increase the thickness of the adhesive laminate and enhance the durabilities for tension of the adhesive laminate. The at least one cross-linking layer also may increase the compatibilities between the retroreflective substrate adhesive layer and the temporary carrier adhesive layer. The at least one cross-linking layer cross-links with the retroreflective substrate adhesive layer and the temporary carrier adhesive layer respectively and connects there with firmly. Furthermore, the advantage of the present invention is also utilizing the stable coating rate to dispose the cross-linking layer on the surface of retroreflective substrate smoothly and thinly. The drying step with high temperature also accelerates aging of the cross-linking layer.

### BRIEF DESCRIPTION OF THE DRAWINGS

FIG. 1 is a cross-sectional side view of an adhesive laminate of Embodiment 1 of the present invention, shown laminated with a retroreflective substrate and a temporary carrier;

FIG. 2 is a cross-sectional side view of an adhesive laminate of Embodiment 2 of the present invention, shown laminated with a retroreflective substrate and a temporary carrier;

FIG. 3 is a flow chart of a method for making retroreflective tapes with the adhesive laminate in accordance with Embodiment 1 of the present invention;

FIG. 4 is a flow chart of a method for making retroreflective tapes with the adhesive laminate in accordance with Embodiment 2 of the present invention;

FIG. 5 is a cross-sectional side view of a conventional first type retroreflective substrate laminated with liner; and

FIG. 6 is a cross-sectional side view of a conventional second type retroreflective substrate laminated with liner.

### DETAILED DESCRIPTION OF THE INVENTION

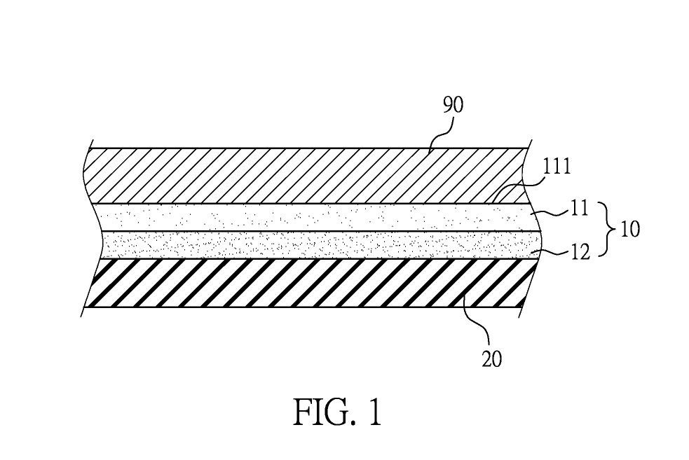

As shown in FIG. 1, a first embodiment of the present invention provides an adhesive laminate 10 that comprises a retroreflective substrate adhesive layer 11 and a temporary carrier adhesive layer 12.

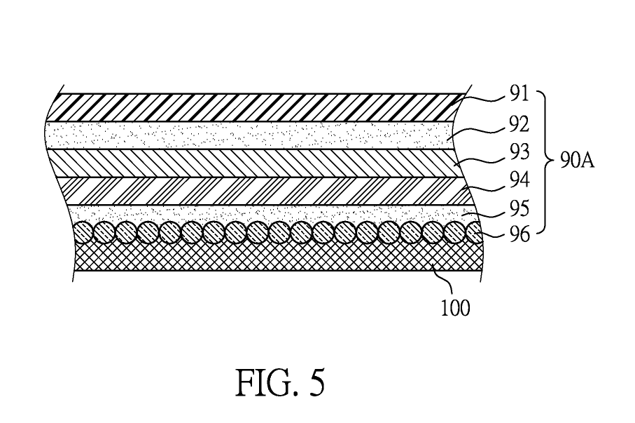

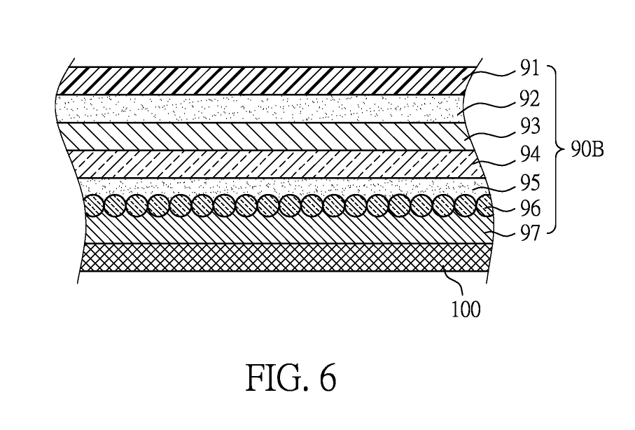

The retroreflective substrate adhesive layer 11 comprises an adhesive surface 111 attached on a side of a retroreflective substrate 90. The retroreflective substrate 90 is a conventional first type retroreflective substrate 90A as shown in FIG. 5 or a conventional second type retroreflective substrate 90B as shown in FIG. 6.

More specifically, the retroreflective substrate adhesive layer 11 of the present invention is coated on the side of the conventional first type retroreflective substrate 90A that is implanteding with a glass sphere-lens layer 96 or is coated on the side of the conventional second type retroreflective substrate 90B that is covering a deposited aluminum layer 97. The adhesive surface 111 of the retroreflective substrate adhesive layer 11 is attached toward the conventional first type retroreflective substrate 90A or the conventional second type retroreflective substrate 90B. The temporary carrier adhesive layer 12 is coated on the other side of the conventional first type retroreflective substrate 90A opposite the retroreflective substrate adhesive layer 11 or coated on the other side of the conventional second type retroreflective substrate 90B opposite the retroreflective substrate adhesive layer 11. The temporary carrier adhesive layer 12 may be attached with a temporary carrier 20 after formation. The retroreflective substrate 90 and the adhesive laminate 10 of the present invention may be peeled off together from the temporary carrier 20 when users are ready to use the retroreflective substrate 90. The retroreflective substrate 90 may be applied on rubber articles such as tires, shoes, balls, and other rubber articles through the adhesive laminate 10 of the present invention.

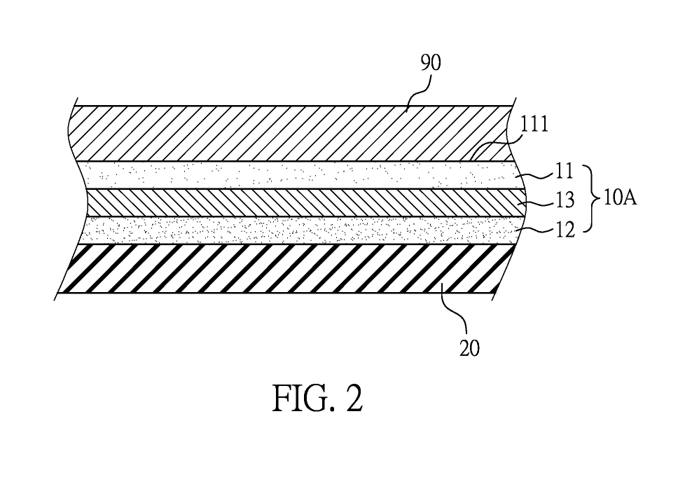

As shown in FIG. 2, a second embodiment of the present invention provides an adhesive laminate 10A that comprises a retroreflective substrate adhesive layer 11, a cross-linking layer 13, and a temporary carrier adhesive layer 12.

The retroreflective substrate adhesive layer 11 comprises an adhesive surface 111 attached on a side of the retroreflective substrate 90. The retroreflective substrate 90 is a conventional first type retroreflective substrate 90A as shown in FIG. 5 or a conventional second type retroreflective substrate 90B as shown in FIG. 6.

More specifically, the retroreflective substrate adhesive layer 11 of the present invention is coated on the side of the conventional first type retroreflective substrate 90A that is implanted with a glass sphere-lens layer 96 or is coated on the side of the conventional second type retroreflective substrate 90B that is covering a deposited aluminum layer 97. The adhesive surface 111 of the retroreflective substrate adhesive layer 11 is attached toward the conventional first type retroreflective substrate 90A or the conventional second type retroreflective substrate 90B. The cross-linking layer 13 is coated on the other side of the conventional first type retroreflective substrate 90A opposite the retroreflective substrate adhesive layer 11 or coated on the other side of the conventional second type retroreflective substrate 90B opposite the retroreflective substrate adhesive layer 11. The temporary carrier adhesive layer 12 is further coated on a side of the cross-linking layer 13. The temporary carrier adhesive layer 12 is opposite the retroreflective substrate adhesive layer 11 with respect to the cross-linking layer 13. The temporary carrier adhesive layer 12 may be attached with a temporary carrier 20 after formation. The retroreflective substrate 90 and the adhesive laminate 10A of the present invention may be peeled off together from the temporary carrier 20 when users are ready to use the retroreflective substrate 90. The retroreflective substrate 90 may be applied on rubber articles such as tires, shoes, balls, and other rubber articles through the adhesive laminate 10A of the present invention.

The retroreflective substrate adhesive layer 11 of the adhesive laminate 10 in the first embodiment and the adhesive laminate 10A in the second embodiment are formed by mixing polyester PU adhesive, toluene diisocyanate (TDI), and 4,4′ methylenediphenyl diisocyanate (MDI). The weight ratio among the polyester PU adhesive, TDI, and MDI is 100:1:1.5. The viscosity of the above mixture may be regulated by adding methyl ethyl ketone (MEK). The viscosity is not limited but adjustable on demand.

The temporary carrier adhesive layer 12 of the adhesive laminate 10 in the first embodiment and the adhesive laminate 10A in the second embodiment comprises rubber adhesive respectively. A rubber component of the rubber adhesive further comprises: natural rubber, styrene-butadiene rubber (SBR), mineral oil (applied as plasticizer), stearic acid (applied as softener), microcrystalline wax (applied as antiozonant), zinc oxide (applied as activator), sulfur (applied as vulcanizing agent), 2,2′-dithiobis(benzothiazole) (MBTS) (applied as vulcanization accelerator), and pentaerythrite tetra [β-(3,5-di-tert-butyl-4-hydroxyphenyl)-propionate] (applied as antioxidant). The best weight ratio among the natural rubber, SBR, mineral oil, stearic acid, microcrystalline wax, zinc oxide, sulfur, MBTS, and pentaerythrite tetra [β-(3,5-di-tert-butyl-4-hydroxyphenyl)-propionate] is 60:30:5:2:1.5:3:1.5:1:0.2. The temporary carrier adhesive layer 12 of the adhesive laminate 10 in the first embodiment and the adhesive laminate 10A in the second embodiment comprises: rubber component, carbon black, hydrocarbon resin (applied as tackifier), polybutene (PB) (applied as plasticizer), bis(triethoxy)silane derivative (applied as silane coupling agent), and solvent. The best weight ratio among the rubber component, carbon black, hydrocarbon resin, PB, bis(triethoxy)silane derivative and solvent is 2.5:1.25:1.3:0.45:0.05:6.7.

The cross-linking layer 13 of the adhesive laminate 10A in the second embodiment comprises rubber adhesive. A rubber component of the rubber adhesive further comprises: natural rubber, SBR, mineral oil (applied as plasticizer), stearic acid (applied as softener), microcrystalline wax (applied as antiozonant), zinc oxide (applied as activator), sulfur (applied as vulcanizing agent), MBTS (applied as vulcanization accelerator), and pentaerythrite tetra [β-(3,5-di-tert-butyl-4-hydroxyphenyl)-propionate] (applied as antioxidant). The best weight ratio among the natural rubber, SBR, mineral oil, stearic acid, microcrystalline wax, zinc oxide, sulfur, MBTS, and pentaerythrite tetra [β-(3,5-di-tert-butyl-4-hydroxyphenyl)-propionate] is 60:30:5:2:1.5:3:1.5:1:0.2. The cross-linking layer 13 with the adhesive laminate 10A in the second embodiment comprises: rubber component, silicon dioxide, hydrocarbon resin (applied as tackifier), PB (applied as plasticizer), bis(triethoxy)silane derivative (applied as silane coupling agent), and solvent. The best weight ratio among the rubber component, silicon dioxide, hydrocarbon resin, PB, bis(triethoxy)silane derivative and solvent is 2.5:1.25:1.3:0.45:0.05:6.7.

The other cross-linking layer 13 of the adhesive laminate 10A in the second embodiment comprises a translucent rubber adhesive. The translucent rubber adhesive is mixed by rubber component, silicon dioxide, hydrocarbon resin (applied as tackifier), PB (applied as plasticizer), bis(triethoxy)silane derivative (applied as silane coupling agent), and solvent. The best weight ratio among the rubber component, silicon dioxide, hydrocarbon resin, PB, bis(triethoxy)silane derivative and solvent is 2.5:1.25:1.3:0.45:0.05:6.7. The other cross-linking layer 13 of the adhesive laminate 10A in the second embodiment is mixed by the translucent rubber adhesive and the above components with the retroreflective substrate adhesive layer 11. The best weight ratio between the translucent rubber adhesive and the above components with the retroreflective substrate adhesive layer 11 is 1:1.

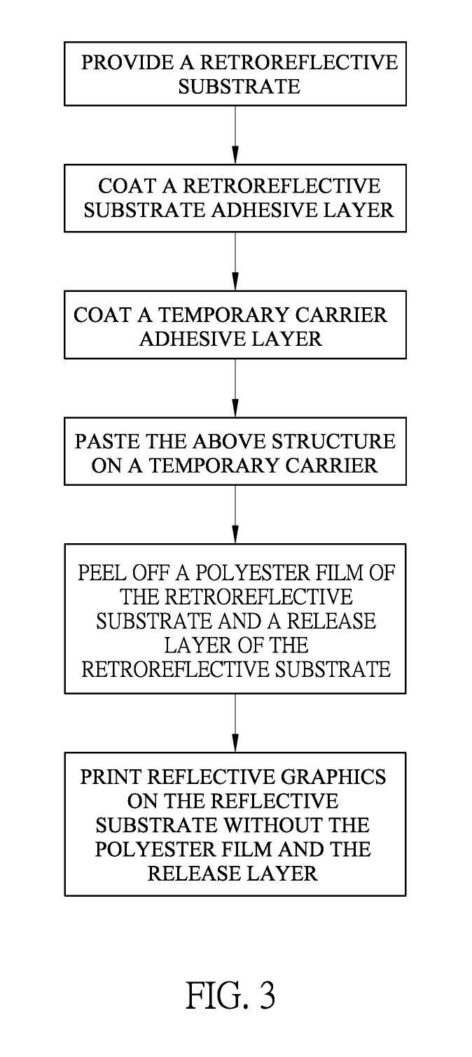

A method for making a retroreflective substrate with the adhesive laminate 10 in accordance with the first embodiment of the present invention, as shown in FIGS. 3, 5, and 6, provides a conventional retroreflective substrate 90 firstly such as the first type retroreflective substrate 90A or the second type retroreflective substrate 90B. Coat the retroreflective substrate adhesive layer 11 with the above components at a rate of 3 m to 20 m per minute on a side of the retroreflective substrate 90. The retroreflective substrate adhesive layer 11 is opposite the polyester film 91 and the release layer 92 with respect to the retroreflective substrate 90. The thickness of the retroreflective substrate adhesive layer 11 ranges from 0.04 mm to 0.1 mm. The retroreflective substrate adhesive layer 11 undergoes three-stage drying by hot air at 80° C., 100° C., and 115° C. The retroreflective substrate adhesive layer 11 is naturally aging for about 2 to 10 hours after the three-stage drying. The preparation of the retroreflective substrate adhesive layer 11 for the retroreflective substrate 90 is achieved through the above steps.

Coat the temporary carrier adhesive layer 12 with the above components at a rate of 3 m to 20 m per minute on a side of the retroreflective substrate 90. The temporary carrier adhesive layer 12 is opposite the retroreflective substrate adhesive layer 11 with respect to the retroreflective substrate 90. The thickness of the temporary carrier adhesive layer 12 ranges from 0.04 mm to 0.1 mm. The temporary carrier adhesive layer 12 undergoes three-stage drying by hot air at 80° C., 115° C., and 120° C. The temporary carrier adhesive layer 12 is naturally aging for about 2 to 10 hours after the three-stage drying. The preparation of the temporary carrier adhesive layer 12 for the retroreflective substrate 90 is achieved through the above steps.

The temporary carrier adhesive layer 12 is attached on the temporary carrier 20 finally. The temporary carrier adhesive layer 12 is isolated from dusts in the air before applying on rubber articles such as tires and shoes. The adhesion to the retroreflective substrate 90 may be preserved.

The retroreflective substrate with the adhesive laminate 10 of the first embodiment is completed for preliminary preparation. Users may peel off the polyester film 91 and the release layer 92 first to print reflective graphics on the reflective substrate 90. The surface coating 93 is exposed after the polyester film 91 and the release layer 92 are peeled off. The reflective graphics are printed on the coating surface 93 by any method such as screen printing or letterpress printing. The reflective graphics may produce diverse decorations to the retroreflective substrate.

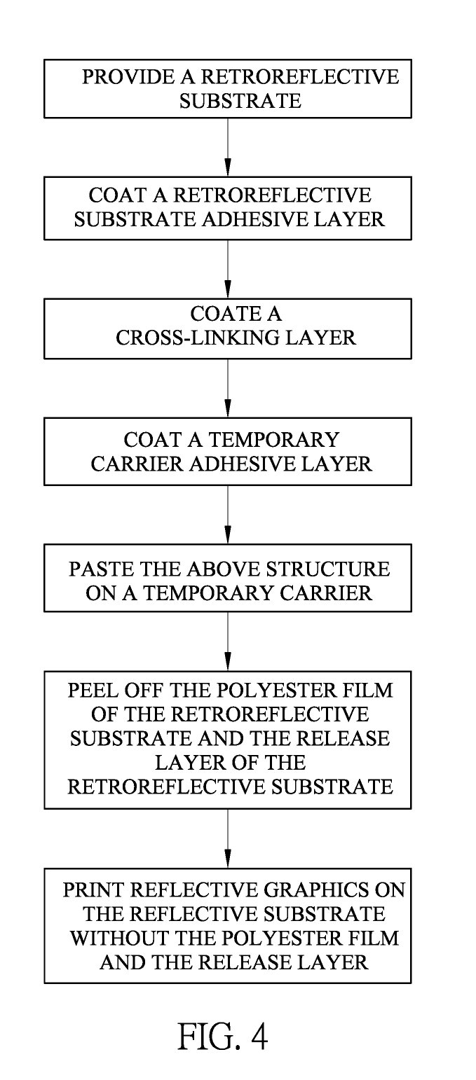

Another method for making a retroreflective substrate with the adhesive laminate 10A in accordance with the second embodiment of the present invention is as shown in FIGS. 4, 5, and 6. The difference from the method of making Embodiment 1 is that the cross-linking layer 13 is further coated on a side of the retroreflective substrate adhesive layer 11 opposite the retroreflective substrate 90 at a rate of 3 m to 20 m per minute after preparation of the retroreflective substrate adhesive layer 11 on the retroreflective substrate 90. The thickness of the cross-linking layer 13 ranges from 0.04 mm to 0.15 mm. The cross-linking layer 13 undergoes three-stage drying by hot air at 80° C., 115° C., and 125° C. The cross-linking layer 13 is naturally aging for about 2 to 10 hours after the three-stage drying. The preparation of the cross-linking layer 13 for the retroreflective substrate 90 is achieved through the above steps. The temporary carrier adhesive layer 12 is coated by the above method on a side of the cross-linking layer 13. The temporary carrier adhesive layer 12 is opposite the retroreflective substrate adhesive layer 11 with respect to the cross-linking layer 13. The attachment of the temporary carrier 20 and the steps of the printing reflective graphics have been described above.

Moreover, the cross-linking layer 13 of the present invention may be coated repeatedly in multiple layers on the retroreflective substrate adhesive layer 11. The temporary carrier adhesive layer 12 is made on the outermost layer of the cross-linking layer 13. The multiple layers of the cross-linking layers 13 may enhance the structural strength of the adhesive laminate 10A. The adhesive laminate 10A of the present invention would not to be cracked by bending and stretching. Number of the multiple cross-linking layers 13 in this method is not limited.

In summary, the adhesive laminate 10, 10A of the present invention may not only be laminated with the glass sphere-lens layer 96 of the conventional first type retroreflective substrate 90A and the deposited aluminum layer 97 of the conventional second type retroreflective substrate 90B respectively, but also has better adhesion to the rubber articles than conventional liner 100. The adhesive laminate 10, 10A helps the retroreflective substrate 90 to firmly attach on the rubber articles for a long term. The adhesive laminate 10, 10A enhances the capabilities of the retroreflective substrate 90 to attach on the rubber articles. The adhesive laminate 10, 10A of the present invention has better compatibilities and adhesion to the rubber articles than the conventional liner 100. The retroreflective substrate 90 with the adhesive laminate 10, 10A may not be damaged by bending and stretching during the attachment process. It does not influence the appearance of the retroreflective substrate 90. In addition, the thicknesses of the retroreflective substrate adhesive layer 11, the temporary carrier adhesive layer 12, and the cross-linking layer 13 in the adhesive laminate 10, 10A provide adequate supporting forces to maintain the rigidity of each layer. The rigidity helps the adhesive laminate 10, 10A to prevent the retroreflective substrate 90 getting too soft to affect the convenience during the attachment process. It also enhances the tolerance from bending and stretching of the retroreflective substrate 90 during the attachment process simultaneously.

What is claimed is:

1. An adhesive laminate comprising:
a retroreflective substrate adhesive layer having an adhesive surface and comprising resin and a solvent; and
a temporary carrier adhesive layer disposed on a surface of the retroreflective substrate adhesive layer opposite the adhesive surface and comprising a rubber adhesive.

2. The adhesive laminate as claimed in claim 1, wherein at least one cross-linking layer is formed between the retroreflective substrate adhesive layer and the temporary carrier adhesive layer; the at least one cross-linking layer comprises: polyurethane (PU) and a rubber adhesive.

3. The adhesive laminate as claimed in claim 1, wherein the resin is PU, acrylic, epoxy, or a combination thereof.

4. The adhesive laminate as claimed in claim 3, wherein the PU is a PU adhesive; the PU adhesive comprises at least one diisocyanate, at least one polyisocyanate, at least one polyol, at least one product from unsaturated polyol, and at least one chain extender.

5. The adhesive laminate as claimed in claim 4, wherein the at least one diisocyanate and the at least one polyisocyanate are respectively aliphatic isocyanate, alicyclic isocyanate, aromatic isocyanate, heterocyclic isocyanate, or a combination thereof; the at least one polyol is polycaprolactone (PCL) polyol, polycarbonate polyol, PU diol, polyester polyol, or a combination thereof; the at least one product from unsaturated polyol is hydroxyl-terminated polybutadiene (HTPB) material or hydroxyl-terminated butadiene acrylonitrile cooligomer liquid rubber; and the at least one chain extender is diol or triol.

6. The adhesive laminate as claimed in claim 1, wherein the rubber adhesive comprises: a rubber component, a tackifier, a plasticizer, and an additive; and the additive is a vulcanizing agent or a silane coupling agent.

7. The adhesive laminate as claimed in claim 6, wherein the rubber component is natural rubber, synthetic rubber, or a combination thereof; the synthetic rubber is chloroprene rubber (CR), styrene butadiene rubber (SBR), polybutadiene rubber (BR), nitrile butadiene rubber (NBR), isoprene rubber (IR), butyl rubber (IIR), ethylene propylene diene monomer rubber (EPDM), or a combination thereof; the tackifier is rosin ester, polymerized rosin, terpene, polyterpene, styrenated terpene, terpene phenolic, petroleum hydrocarbon, or a combination thereof; the plasticizer is mineral oil, polybutene (PB), isoprene rubber, or a combination thereof; the vulcanizing agent is sulfur or 4,4′-dithiodimorpholine; the silane coupling agent is triethoxyoctylsilane, 3-(glycidoxypropyl)methyldiethoxysilane, bis(triethoxy)silane derivative, or a combination thereof.

8. The adhesive laminate as claimed in claim 1, wherein the retroreflective substrate adhesive layer further comprises ink.

9. A method for making retroreflective tapes with an adhesive laminate as claimed in claim 1 comprising:
providing a retroreflective substrate;
coating the retroreflective substrate adhesive layer on a side of the retroreflective substrate;
coating the temporary carrier adhesive layer on another side of the retroreflective substrate opposite the retroreflective substrate adhesive layer;
pasting a temporary carrier on a side of the temporary carrier adhesive layer opposite the retroreflective substrate adhesive layer.

10. The method for making retroreflective tapes with an adhesive laminate as claimed in claim 9, wherein at least one cross-linking layer is coated between the retroreflective substrate adhesive layer and the temporary carrier adhesive layer.

11. The method for making retroreflective tapes with an adhesive laminate as claimed in claim 9, wherein the thickness of the retroreflective substrate adhesive layer ranges from 0.04 mm to 0.1 mm; the thickness of the temporary carrier adhesive layer ranges from 0.04 mm to 0.1 mm.

12. The method for making retroreflective tapes with an adhesive laminate as claimed in claim 10, wherein the thickness of the cross-linking layer ranges from 0.04 mm to 0.15 mm.
